(19) United States
(12) Patent Application Publication
(10) Pub. No.: US 2009/0313221 A1
(43) Pub. Date: Dec. 17, 2009

(54) PATENT TECHNOLOGY ASSOCIATION CLASSIFICATION METHOD

(76) Inventors: Chien-Hsun Chen, Longtan Township (TW); Yueh-Hsuan Weng, Longtan Township (TW)

Correspondence Address: HDLS Patent & Trademark Services, P.O. BOX 220746, CHANTILLY, VA, 20153-0746, US

(21) Appl. No.: 12/140,380

(22) Filed: Jun. 17, 2008

(51) Int. Cl. G06F 7/10; G06F 17/30

(52) U.S. Cl. 707/3; 707/E17.014

(57) ABSTRACT

A patent technology association classification method includes the steps of inputting a search data, searching for patent specifications matched with the search data, retrieving subject matter classification codes from each patent specification, creating an association classification code group for the subject matter classification codes corresponding the patent specifications, comparing the subject matter classification codes common to the association classification code group two by two, creating a common classification code group for the subject matter classification codes corresponding to the patent specifications in two association classification code groups, and determining an association level of each patent specification according to the quantity of the common subject matter classification codes in each common classification code group, so as to provide a method of analyzing the association level (or similarly) of the patent specifications.

### BACKGROUND OF THE INVENTION

1. Field of the Invention

The present invention generally relates to an association classification method, and more particularly to a patent technology association classification method.

2. Description of Prior Art

In a patent analysis, a patent layout or a patent search is an indispensable activity for enterprises, and it is necessary to search a patent specification from a database by using a keyword or carry out patent bibliometrics during a patent analysis and output the result in charts, and the patent bibliometrics can provide a wide range of patent information generally having a significant effect on the final decision of the patent analysis.

In addition, the patent citation analysis employs a patent analysis method using a patent citation network for the analysis, but the accuracy of the analysis is limited by the technologies, since the method of establishing the patent citation network involves a technique of processing a natural language.

As the number of patent specifications of patent applications increases annually, a huge number of patent specifications will cause a big problem for research and development engineers of a corporation to read and arrange the patent specifications. Therefore, it is necessary to analyze the patent specifications or patent applications of other companies by a patent analysis software or take necessary design-around layout to handle the research and development technologies and layout quickly and thoroughly.

At present, the patent analysis software such as PatentGuider developed by LearningTech Corporation can process a large quantity of patent data and analyze the large quantity of patent data in a chart by the number of patents, country, inventors, the number of cites per patent rate, and IPC or UPC, and provide statistical data and charts, but these software cannot analyze and compare the association level (or similarity) of the contents of the patent specifications.

Therefore, users require assistances provided by staffs with professional technical knowledge to determine whether or not two patent specifications are associated (or similar) with or there is a patent infringement. Furthermore, users have to spend lots of time and efforts on reading and determining the patent specifications as the number of patent applications increases.

### SUMMARY OF THE INVENTION

In view of the shortcomings of the prior art, it is a primary objective of the present invention to provide a patent technology association classification method that adjusts the quantity of subject matter classification codes common to a classification code group to analyze the association level (or similarity) of each patent specification.

To achieve the foregoing objective, the invention provides a patent technology association classification method, comprising the steps of: inputting a search data; searching for a plurality of patent specifications matched with the search data; retrieving a plurality of subject matter classification codes from each patent specification; creating an association classification code group for the subject matter classification codes corresponding the patent specifications; comparing the subject matter classification codes common to the association classification code group two by two; creating a common classification code group for the subject matter classification codes corresponding to the patent specifications in two association classification code groups; and determining an association level of each patent specification according to the quantity of the common subject matter classification codes in each common classification code group.

The invention further comprises a step of adjusting the quantity of the subject matter classification codes common to the classification code group to search for the patent specification with the association level, after the step of determining the association level of each patent specification.

Compared with the prior art, the patent technology association classification method of the invention can achieve a function of determining an association level (or similarity) among patent specifications to overcome the shortcomings of the prior art that cannot perform an analysis of the contents of the patent specifications.

### BRIEF DESCRIPTION OF DRAWINGS

FIG. 1 is a flow chart of a first preferred embodiment of the present invention;

FIG. 2 is a flow chart of a second preferred embodiment of the present invention; and

FIG. 3 is a flow chart of a third preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. It is noteworthy to point out that the drawings are provided for illustrating the invention, but not intended for limiting the scope of the invention.

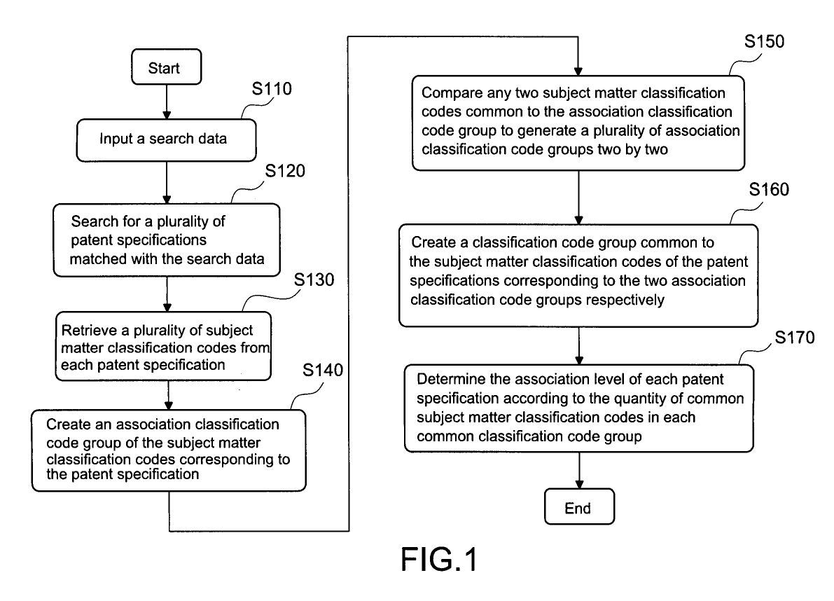

Referring to FIG. 1 for a flow chart of a patent technology association classification method in accordance with a first preferred embodiment of the present invention, the method comprises the following steps:

Step S110: Input a search data, wherein the search data can be a subject matter classification code, a year range, a keyword or a combination of the above, and the subject matter classification code can be a Japanese F-Term classification code, a U.S. patent classification code (UPC) or an international patent classification code (IPC), and the year range can be the range of a year, several years or falling between each year, and the keyword can be a keyword or a plurality of keywords. For example, the Japanese F-Term classification code 3C027 is inputted, then the search range is set to a range of technical area of 3C027, or the data of the year range such as 2005˜2007 and the keyword such as “Paper cutting” are inputted. Further, the subject matter classification code, the year range or the keyword can be inputted separately.

Step S120: Search for a plurality of patent specifications matched with the search data. Based on the foregoing inputted search data, users can search related patent specifications in a technical area range of 3C027 with the keyword “Paper cutting” from 2005 to 2007. If the subject matter classification code, the year range or the keyword is inputted separately for executing the search, then the association level among the searched patent specifications is relatively low. If the subject matter classification code, the year range and the keyword are inputted in the forgoing step as the search conditions, then the association level among the searched patent specifications will be relatively high.

Step S130: Retrieve a plurality of subject matter classification codes from each patent specification. The method further comprises the steps of retrieving a patent number from the patent specification after the step of retrieving the subject matter classification codes from the patent specification and retrieving the patent number and the subject matter classification codes from each patent specification after the step of searching the related patent specifications, wherein the retrieved subject matter classification code includes only one subject matter classification code or a plurality of subject matter classification codes, and the quantity of subject matter classification codes depends on the quantity of subject matter classification codes in the patent specification.

Step S140: Create an association classification code group of the subject matter classification codes corresponding to the patent specification, wherein the step of creating the association classification code group of the subject matter classification codes corresponding to the patent specification further includes the step of creating the association classification code group of the subject matter classification codes corresponding to the patent number; and creating a record of the association classification code group of the subject matter classification codes corresponding to the patent number after all subject matter classification codes in the patent specification are retrieved, and the association classification code group includes the subject matter classification codes associated closely with the classification of the technical area of the patent specification, and thus each association classification code group of each patent specification is created one by one to generate a multiple records of the association classification code groups.

Step S150: Compare any two subject matter classification codes common to the association classification code group to generate a plurality of association classification code groups, wherein the subject matter classification codes in an association classification code group and the subject matter classification codes in another association classification code group are compared. For example, the subject matter classification codes in an association classification code group include 3C027JJ08, 3C027JJ09 and 3C024FF02, and the subject matter classification codes in the association classification code group include 3C027JJ08, 3C027JJ09 and 3C058AA00, and the subject matter classification codes common to an association classification code group and another association classification code group include 3C027JJ08 and 3C027JJ09. In this step, a plurality of association classification code groups are compared with each other, but not limited to the comparison of any two association classification code groups only.

Step S160: Create a classification code group common to the subject matter classification codes of the patent specifications corresponding to the two association classification code groups respectively, and the step of creating the common classification code group further includes the step of creating a patent network interconnection architecture linked among the subject matter classification codes. For example, the subject matter classification codes 3C027JJ08 and 3C027JJ09 common to the association classification code group and the other association classification code group are created as a record of data of the common classification code group, and the data are compared one by one in the foregoing step to generate a plurality of records of the common classification code groups. For example, the common classification code group includes the common subject matter classification codes 3C027JJ08 and 3C027JJ09, and the other common classification code group includes the common subject matter classification codes 3C027JJ08, 3C058AA00 and 3C058AA02, and a link is created among the common subject matter classification codes in a common classification code group and a link is created among the common subject matter classification codes in the other common classification code group to constitute the patent network interconnection architecture, wherein the patent network interconnection architecture shows the association level of the patent specifications by a chart, a figure or their combination.

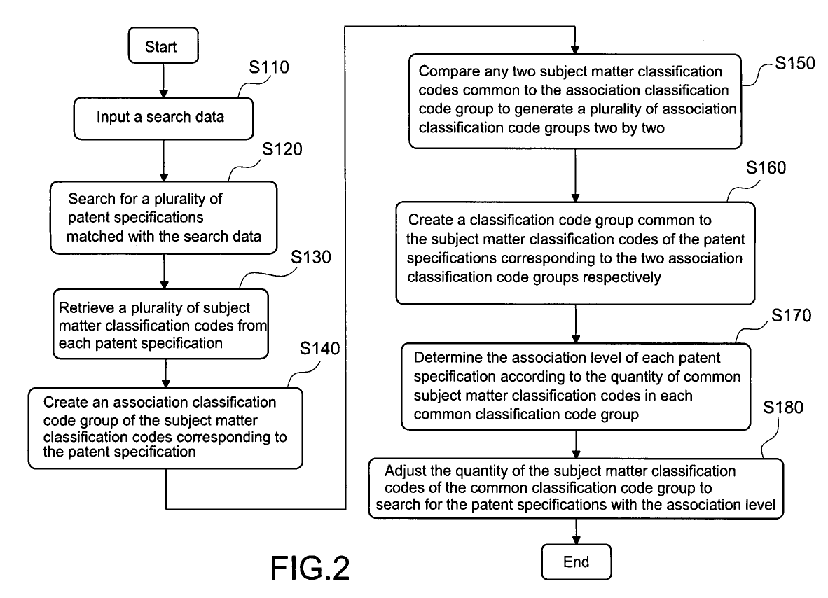

Step S170: Determine the association level of each patent specification according to the quantity of common subject matter classification codes in each common classification code group, wherein there are two common subject matter classification codes in the common classification code group in the foregoing step and three common subject matter classification codes in the other common classification code group, and thus the quantity of common subject matter classification codes in the other common classification code group is greater than the quantity of common subject matter classification codes in the common classification code group. Therefore, we can determine that the association level of the patent specifications having the subject matter classification codes corresponding to the other common classification code group is relatively higher, or in other words, the patent specifications have a higher similarity. On the other hand, the association level of the patent specifications having the subject matter classification codes corresponding to the common classification code group is relatively lower, or in other words, the patent specifications have a lower similarity. Referring to FIG. 2 for a flow chart of a second preferred embodiment of the present invention, the major difference of this embodiment from the first preferred embodiment resides on that the method of this embodiment further comprises the Step SI 80 of adjusting the quantity of the subject matter classification codes of the common classification code group to search for the patent specifications with the association level after the step S170. If the adjusted quantity of the subject matter classification codes of the common classification code group is greater, then the quantity of the patent specifications will become less, and the association level (or similarity) of the patent specifications will become higher. On the other hand, if the adjusted quantity of the subject matter classification code of the common classification code group is smaller, then the quantity of the patent specifications will become more, and the association level (or similarity) of the patent specifications will become lower.

With the method of the present invention, users can adjust the quantity of the subject matter classification codes of the common classification code group to determine the association level of each patent specification. If the adjusted quantity of the subject matter classification codes of the common classification code group is greater, the patent specifications with a high similarly will be kept. If the adjusted quantity of the subject matter classification codes of the common classification code group is less, then the patent specifications with a lower similarity will be kept.

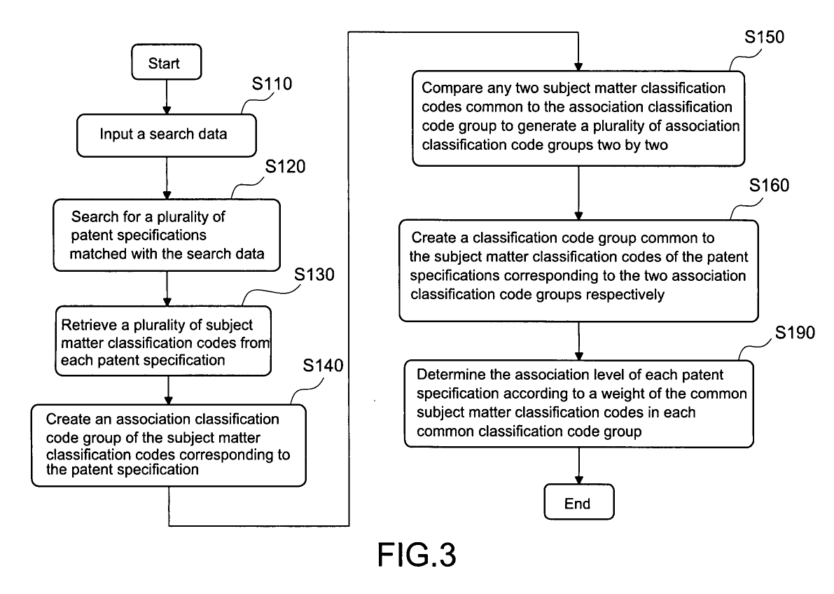

Referring to FIG. 3 for a flow chart of a third preferred embodiment of the present invention, the major difference of this embodiment from the first preferred embodiment resides on that the method of this embodiment further comprises the Step S 190 of determining the association level of each patent specification according to a weight of the common subject matter classification codes in each common classification code group after the step S170, wherein the weight is the frequency of each subject matter code of the subject matters occurred in each patent specification. For example, the common classification code group includes the common subject matter classification codes 3C027JJ08 and 3C027JJ09, and the other common classification code group includes the common subject matter classification codes 3C027JJ08, 3C058AA00 and 3C058AA02. If the frequency of the subject matter classification code 3C027JJ08 showing up in each patent specification is once, then the weight of the subject matter classification code 3C027JJ08 is set to 1. If the frequency of the subject matter classification code 3C027JJ09 showing up in each patent specification is five times, then the weight of the subject matter classification code 3C027JJ09 is set to 5. If the frequency of the subject matter classification code 3C058AA00 showing up in each patent specification is once, then the weight of the subject matter classification code 3C058AA00 is set to 1. If the frequency of the subject matter classification code 3C058AA02 showing up in each patent specification is twice, then the weight of the subject matter classification code 3C058AA02 is set to 2. The weight of the common subject matter classification codes in the common classification code group adds up to 6, and the weight of the common subject matter classification codes in the other common classification code group adds up to 4, and the association level (or similarity) of the patent specifications in the common classification code group are relatively higher, and the association level of the patent specifications in the other common classification code group is relatively lower.

In this preferred embodiment, a weight is used for determining the association level of each patent specification to enhance the accuracy of the analysis and the association level of the patent specifications. In summation of the description above, the function of the present invention is provided for determining the association level of each patent specification and overcoming the shortcomings of the prior art.

While the invention is described in by way of examples and in terms of preferred embodiments, it is to be understood that the invention is not limited thereto. On the contrary, the aim is to cover all modifications, alternatives and equivalents falling within the spirit and scope of the invention as defined by the appended claims.

What is claimed is:

1. A patent technology association classification method, comprising the steps of:
inputting a search data;
searching for a plurality of patent specifications matched with the search data;
retrieving a plurality of subject matter classification codes from each patent specification;
creating an association classification code group for the subject matter classification codes corresponding the patent specifications;
comparing the subject matter classification codes common to the association classification code group two by two;
creating a common classification code group for the subject matter classification codes corresponding to the patent specifications in two association classification code groups; and
determining an association level of each patent specification according to the quantity of the common subject matter classification codes in each common classification code group.

2. The patent technology association classification method of claim 1, wherein the search data is the subject matter classification code.

3. The patent technology association classification method of claim 2, wherein the subject matter classification code is a F-Term classification code.

4. The patent technology association classification method of claim 2, wherein the subject matter classification code is a U.S. patent classification code (UPC).

5. The patent technology association classification method of claim 2, wherein the subject matter classification code is an international patent classification code (IPC).

6. The patent technology association classification method of claim 1, wherein the search data is a year range.

7. The patent technology association classification method of claim 1, wherein the search data is at least one keyword.

8. The patent technology association classification method of claim 1, further comprising the step of retrieving a patent number from the patent specification, after the step of retrieving the subject matter classification codes from each patent specification.

9. The patent technology association classification method of claim 8, wherein the step of creating the association classification code group further comprises the step of creating the association classification code group of the subject matter classification codes corresponding to the patent numbers.

10. The patent technology association classification method of claim 1, wherein the step of creating a common classification code group further comprises the step of creating a common patent network interconnection architecture linked among the subject matter classification codes.

11. The patent technology association classification method of claim 1, further comprising the step of adjusting the quantity of the subject matter classification codes of the common classification code group to search for the patent specifications with the association level, after the step of determining an association level of each patent specification.

12. A patent technology association classification method, comprising:
inputting a search data;
searching for a plurality of patent specifications matched with the search data;
retrieving a plurality of subject matter classification codes from each patent specification;
creating an association classification code group for the subject matter classification codes corresponding to the patent specification;
comparing any two subject matter classification codes common to the association classification code group two by two;
creating a common classification code group for the subject matter classification codes corresponding to the patent specifications in two association classification code groups; and
determining an association level of each patent specification according to the weight of the common subject matter classification codes in each common classification code group.

13. The patent technology association classification method of claim 12, wherein the search data is the subject matter classification code.

14. The patent technology association classification method of claim 13, wherein the subject matter classification code is a F-Term classification code.

15. The patent technology association classification method of claim 13, wherein the subject matter classification code is a U.S. patent classification code (UPC).

16. The patent technology association classification method of claim 13, wherein the subject matter classification code is an international patent classification code (IPC).

17. The patent technology association classification method of claim 12, wherein the search data is a year range.

18. The patent technology association classification method of claim 12, wherein the search data is at least one keyword.

19. The patent technology association classification method of claim 12, further comprising the step of retrieving a patent number from the patent specification, after the step of retrieving the subject matter classification codes from each patent specification.

20. The patent technology association classification method of claim 19, wherein the step of creating the association classification code group further comprises the step of creating the association classification code group for the subject matter classification codes corresponding to the patent number.

21. The patent technology association classification method of claim 12, wherein the step of creating the common classification code group further comprises the step of creating a common patent network interconnection architecture linked among the subject matter classification codes.

22. The patent technology association classification method of claim 12, wherein the weight is the frequency of each common subject matter code showing up in the subject matters.
